(19) United States
(12) Patent Application Publication
(10) Pub. No.: US 2016/0275621 A1
(43) Pub. Date: Sep. 22, 2016

(54) CLAIM SUMMARY AND CLAIM WATCH SYSTEM AND METHOD

(71) Applicant: Independent Mitigation and Cleaning/Conservation Network, Inc., Naperville, IL (US)

(72) Inventors: Patrick H. HARMON, Naperville, IL (US); Nathan HART, Naperville, IL (US)

(21) Appl. No.: 15/168,701

(22) Filed: May 31, 2016

Related U.S. Application Data
(62) Division of application No. 13/952,876, filed on Jul. 29, 2013.

(51) Int. Cl. G06Q 40/08; G06F 3/0484; G06F 3/0481

(52) U.S. Cl. CPC G06Q 40/08; G06F 3/0481; G06F 3/04842

(57) ABSTRACT

A claim summary server causes to be displayed an insurance claim summary page associated with an insurance claim. The insurance claim summary page includes identifying information and job information related to the insurance claim. When selection of a job title in the job information occurs, the server causes to be displayed detailed information about a job associated with the insurance claim. When selection of a dollar amount in the job information occurs, the server causes to be displayed an original written estimate. When an estimate processing option in the job information is selected, the server performs the selected processing option. A claim watch server receives notification that an insurance claim requires special attention. The claim watch server receives notification of a predefined reason for why the special attention is required. The claim watch server demarcates the insurance claim as requiring the special attention.

### TECHNICAL FIELD

The technical field relates in general to a data processing system for insurance claims management. More specifically, the data processing system provides a summary of insurance claim information that facilitates quick access to claim information by claims adjusters and others. Additionally, the data processing system provides a mechanism for managing a particular insurance claim needing special attention, watching, or monitoring.

### BACKGROUND

Comprehensive insurance claims management systems are known in which insurance adjusters, contractors, and insureds interact to satisfy insurance claims. Typical functionality of these claims management systems includes establishing benchmarks or goals of contractors in completing particular jobs and monitoring progress in achieving the benchmarks or goals by the contractors, facilitating centralized posting of notes such that each party can view notes of other appropriate parties, facilitating centralized posting of relevant documents and photos, recording and tracking payments, and of course maintaining the full range of identifying information of all parties.

Conventional insurance claims management systems present relevant information over multiple web or other application pages such that users are required to expend substantial time navigating these page to obtain the relevant information. FIG. 13 is an example of a single page 1300 presented by a conventional insurance claims management system that would be among multiple pages related to particular insurance claim 1311 given by claim number DN725216. The single page 1300 provides information about a damage mitigation job 1309 being undertaken with respect to the particular insurance claim 1311.

Specifically, the single page 1300 is considered to be a “QuickLook” page 1301 that provides brief information about the damage mitigation job 1309. The brief information includes the name of the adjuster 1313 as well as supplemental information 1315 which includes the claim number, total estimate value, active estimate review status, and various action items. The various action items are seen in expanded detail 1317, where reminders or statements are presented that indicate what actions need to be taken by a respective party to the insurance claim, such as an insurance adjuster, a contractor, and/or an employee of the intermediary enterprise operating the conventional insurance claims management system.

The QuickLook page 1301 may be considered a launching page related to information about the damage mitigation job 1309. A user can access other pages related to the damage mitigation job 1309, including an “Overview” page 1303 (discussed below), a “Journal” page 1305, a “Documents” page 1306, and a “Photos” page 1307. The Documents page 1306 and Photos page 1307 are self-explanatory, each providing data related to the damage mitigation job 1309. The Journal page 1305 includes journal notes from any respective party to the damage mitigation job 1309 and the particular insurance claim 1311.

FIG. 14 presents an additional single page 1400 presented by a conventional insurance claims management system that would be among multiple pages related to the particular insurance claim 1411 given by claim number DN725216. Specifically, the single page 1400 is an example of an Overview page that presents somewhat more detailed information about the reconstruction job 1409 undertaken further to the particular insurance claim 1411 given by claim number DN725216. The Overview page 1400 presents job overview information 1413 regarding the nature of the remedial measures undertaken by a contractor. The Overview page 1400 may further include contractor information 1419 and insurance information 1417. The Overview page 1400 aids in demonstrating that information related to a particular insurance claim is presented on multiple pages.

It should now be noted that the Overview page 1400 is not the Overview page that would be presented if the Overview tab 1303 were selected in FIG. 13. This is because FIG. 13 relates to the damage mitigation job 1309, and FIG. 14 relates the reconstruction job 1409, associated with the particular insurance claim 1311 or 1411 given by claim number DN725216. The QuickLook page 1300 of FIG. 13 and the Overview page 1400 of FIG. 4 demonstrate that each particular insurance claim may have multiple jobs associated therewith. Such jobs may include, for example, damage mitigation, reconstruction, electronics, household contents, hazmat, textile reconstruction, tree removal, and mold remediation. Thus for each claim number, there may be multiple job associated therewith, and for each job there may be multiple information pages associated therewith.

It should be clear that a user of a conventional insurance claims management systems, such as insurance adjuster, must navigate multiple pages for each of multiple jobs related to a single insurance claim. FIG. 15 illustrates an single page 1500 provided in a conventional insurance claims management system that presents a list of jobs 1503, each associated with a particular insurance claim that the adjuster may be overseeing. Although it would appear that such a list, identified under a “My Claims List” tab 1501, would enable the particular adjuster to rapidly access claim information, this is not the case. Rather, each time the adjuster or other user selects a “Go To Job” hyperlink 1503, the adjuster is taken to a “QuickLook” page 1301 associated with the job which is related to a particular claim number. The adjuster must then navigate the QuickLook page, the Overview page, the Journal page, the Documents page, the Photos page and others to obtain specific information related to a particular claim number.

FIGS. 13-15 demonstrate that a user of a conventional insurance claims management systems, and in particular an insurance adjuster user, must navigate multiple, different application or web pages to obtain relevant information about a particular insurance claim. The embodiments disclosed and claimed herein provide an insurance claim summary system that facilitates a user accessing important information related to a particular insurance claim in a much more fast and efficient manner. However, facilitating access to information is not the only improvement that is needed in conventional insurance claims managements systems.

Specifically, administrator users of conventional insurance claims management systems have no way of identifying, indicating, and/or segregating particular insurance claims that present unusual or problematic issues that may require extra attention, watching, and/or follow-up. That is to say, a user of the conventional insurance claims management system must record and indicate problematic claims by simply providing notes and/or journal entries into records of the particular claim. As discussed above, however, such notes and/or journal entries may be part of voluminous pages related to the particular claim. Indicating that an insurance claim is problematic or needs further attention by simply recording a journal entry creates difficulty in managing these problematic claims.

The present disclosure therefore also presents an insurance claim watch system that allows for insurance claims requiring special attention to be segregated and identified as requiring special attention. Retrieving information related to these problematic claims becomes much simpler. Succinctly put, conventional insurance claims management systems are improved by allowing for unusual or problematic insurance claims to be easily identified and segregated, thereby facilitating a more appropriate management of these claims.

### SUMMARY

Accordingly, a first embodiment disclosed herein provides an insurance claim summary server comprising a transceiver, an electronic data storage, and a processor. The transceiver is operable to transmit and receive communications over at least a portion of a network. The processor is cooperatively operable with the transceiver and the electronic data storage.

The processor is configured to cause to be displayed an insurance claim summary page associated with an insurance claim associated with a claim number. The insurance claim summary page includes identifying information and job information. The identifying information includes the claim number and a subject of the insurance claim.

The job information is related to one or more jobs completed, being undertaken, or intended to be undertaken with respect to the subject of the insurance claim. The job information includes for each of the one or more jobs, a job title, a dollar amount, and plurality of estimate processing options. The dollar amount is an estimated cost provided in an original written estimate to complete the respective job.

The processor is further configured to, when selection of the job title occurs, cause to be displayed detailed information about a respective job. The processor is also configured to, when selection of the dollar amount occurs, cause to be displayed the original written estimate. The processor is lastly configured to, when any one of the estimate processing options are selected, perform the selected processing option with respect to the original written estimate.

A second embodiment disclosed herein provides an insurance claim summary method, implemented in an insurance claim summary server comprising a transceiver, an electronic data storage, and a processor cooperatively operable with the transceiver and the electronic data storage. The method comprises causing by the processor an insurance claim summary page associated with an insurance claim associated with a claim number to be displayed. The insurance claim summary page includes identifying information and job information.

The identifying information includes the claim number and a subject of the insurance claim. The job information is related to one or more jobs completed, being undertaken, or intended to be undertaken with respect to the subject of the insurance claim. The job information includes for each of the one or more jobs, a job title, a dollar amount, and a plurality of estimate processing options. The dollar amount is an estimated cost provided in an original written estimate to complete the respective job.

The method further comprises, when selection of the job title occurs, causing by the processor detailed information about a respective job to be displayed. The method also comprises, when selection of the dollar amount occurs, causing by the processor the original written estimate to be displayed. The method lastly comprises, when selection of any of the processing options occurs, performing by the processor the selected processing option with respect to the original written estimate.

A third embodiment disclosed herein provides a non-transitory computer-readable storage medium. The medium has instructions stored thereon. When executed by a sever computer, comprising a transceiver, an electronic data storage, and processor, the instructions cause the server computer to perform the insurance claim summary method described above.

A fourth embodiment disclosed herein provides an insurance claim watch server comprising a transceiver, an electronic data storage, and a processor. The transceiver is operable to transmit and receive communications over at least a portion of a network. The processor is cooperatively operable with the transceiver and the electronic data storage.

The processor is configured to receive notification that an insurance claim, associated with a claim number, requires special attention. The processor is further configured to receive notification of a predefined reason, chosen from among a plurality of predefined reasons, for why the special attention is required. The processor is lastly configured to demarcate the insurance claim as requiring the special attention.

A fifth embodiment disclosed herein provides an insurance claim watch method, implemented in an insurance claim watch server comprising a transceiver, an electronic data storage, and a processor cooperatively operable with the transceiver and the electronic data storage. The method comprises receiving by the processor notification that an insurance claim, associated with a claim number, requires special attention. The method further comprises receiving by the processor notification of a predefined reason, chosen from among a plurality of predefined reasons, for why the special attention is required. The method lastly acquires demarcating by the processor the insurance claim as requiring the special attention.

A sixth embodiment disclosed herein provides a non-transitory computer-readable storage medium. The medium has instructions stored thereon. When executed by a sever computer, comprising a transceiver, an electronic data storage, and processor, the instructions cause the server computer to perform the insurance claim watch method described above.

It should be quickly noted that the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

### BRIEF DESCRIPTION OF THE DRAWINGS

The accompanying figures, where like reference numerals refer to identical or functionally similar elements and which together with the detailed description below are incorporated in and form part of the specification, serve to further illustrate various exemplary embodiments and to explain various principles and advantages in accordance with the embodiments.

FIG. 1 is a block diagram illustrating an insurance claim summary system, including an insurance claim summary server.

FIG. 2 is a screen capture showing insurance claim summary functionality in general.

FIG. 3 is a screen capture showing insurance claim summary functionality including a note/journal functionality.

FIG. 4 is a screen capture showing insurance claim summary functionality including payment information functionality.

FIG. 5 is a block diagram illustrating an insurance claim summary server configured to implement insurance claim summary functionality.

FIG. 6 is a flow chart illustrating an insurance claim summary method.

FIG. 7 is a block diagram illustrating an insurance claim watch system, including an insurance claim watch server.

FIG. 8 is a screen capture showing insurance claim watch functionality including notification that a particular insurance claim should be watched.

FIG. 9 is a screen capture showing insurance claim watch functionality including demarcation that a particular claim is being watched and the reasons therefore.

FIG. 10 is a screen capture showing insurance claim watch functionality including displays of information related to a particular claim that is being watched in an insurance claim watch system.

FIG. 11 is a block diagram illustrating an insurance claim watch server configured to implement insurance claim watch functionality.

FIG. 12 is a flow chart illustrating an insurance claim watch method.

FIG. 13 is a screen capture of a single page of information, of multiple pages of information, in a conventional insurance claims management system, related to a particular insurance claim.

FIG. 14 is a screen capture of an additional single page of information, of multiple pages of information, in a conventional insurance claims management system, related to a particular insurance claim.

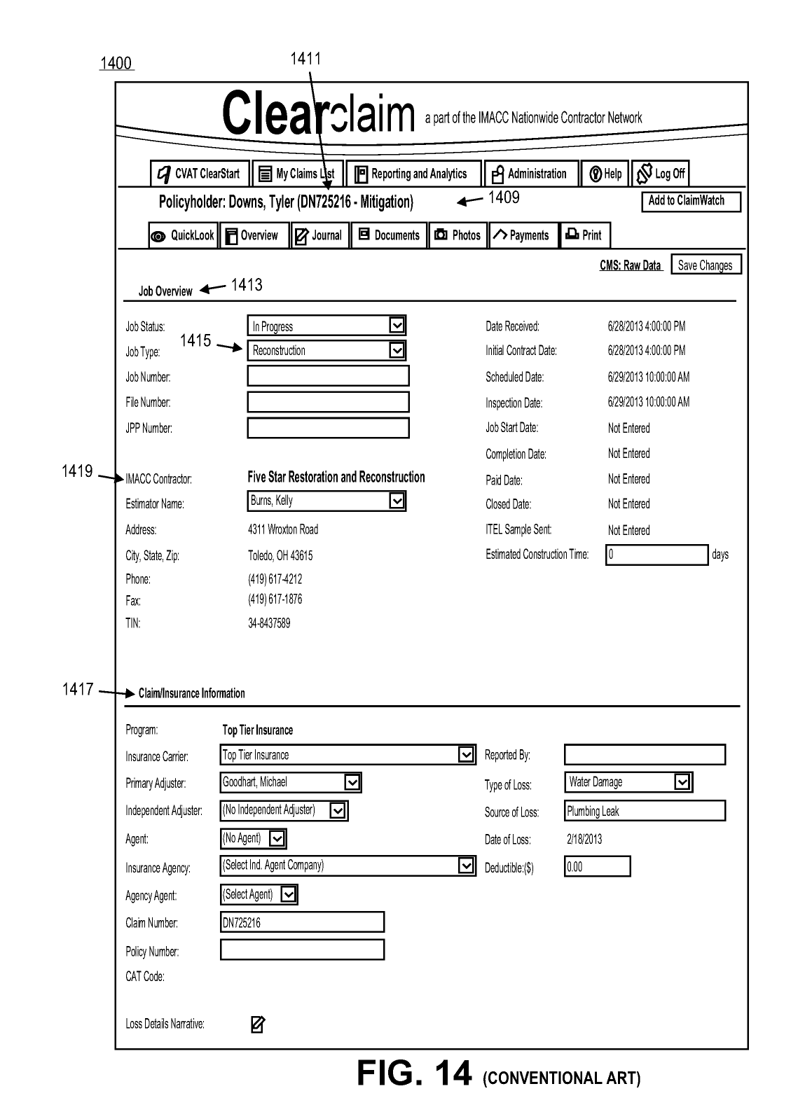

FIG. 15 is a screen capture of a conventional tool for managing multiple jobs associated with a particular insurance claim.

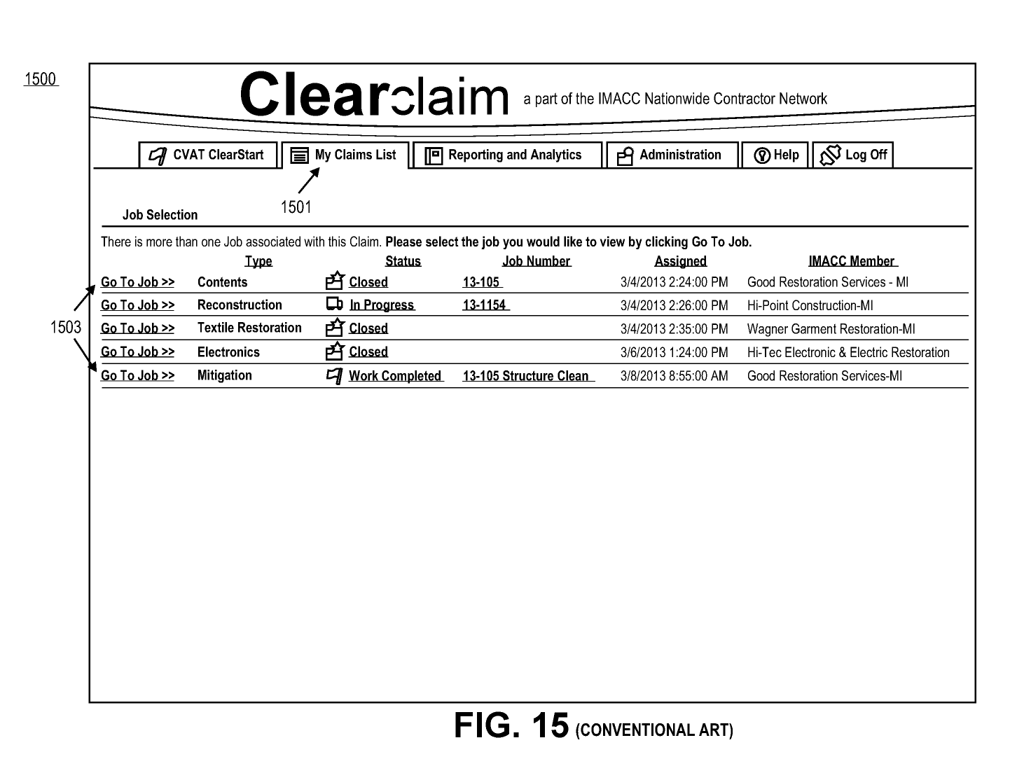

### DETAILED DESCRIPTION

The instant disclosure is provided to further explain in an enabling fashion the best modes of performing one or more embodiments. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented in a processor, are best supported with or in software or integrated circuits (ICs), such as a digital signal processor and software therefore, and/or application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions or ICs with minimal experimentation. Therefore, in the interest of brevity and minimization of any risk of obscuring principles and concepts, further discussion of such software and ICs, if any, will be limited to the essentials with respect to the principles and concepts used by the exemplary embodiments.

As indicated above, the present disclosure concerns an insurance claim summary server that is designed to facilitate a user accessing important information related to a particular claim in a fast and efficient manner. In one embodiment, the insurance claim summary server is configured in an enterprise network of any scale. That is to say, the insurance claim summary server would be operated by an enterprise that is responsible for overseeing management of one or more insurance claims.

In such an environment, the insurance claim summary server would be accessible either at the server itself, or through an enterprise network client device. It is envisioned that the insurance claim summary server is intended to be operated either self-sufficiently, through an operator who is employed by, or responsible to, the enterprise, or by other parties to an insurance claim such as a contractor and an insurance adjuster.

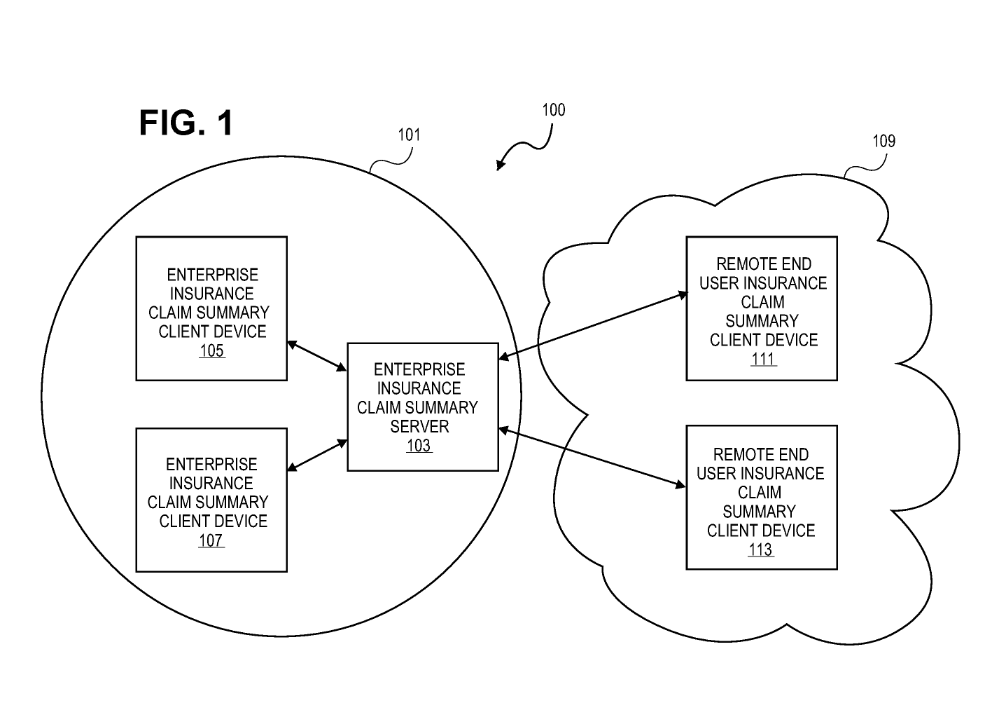

Referring then to FIG. 1, a block diagram illustrating an insurance claim summary system 100 is discussed and described. The insurance claim summary system 100 includes an enterprise network 101 and a remote network 109. In an exemplary embodiment, the enterprise network 101 includes an enterprise insurance claim summary server 103 and one or more enterprise insurance claim summary client devices 105, 107.

As mentioned above, the enterprise insurance claim summary server 103 may be operated by an enterprise which manages one or more insurance claims, and provides resources for operation of the enterprise network 101. While much of the functionality of the enterprise insurance claim summary server 103 is performed autonomously in response to input from remote end user insurance claim summary client devices 111, 113, it should be understood that network administrators and other employees of the enterprise program and operate the enterprise insurance claim summary server 103. Thus the enterprise insurance claim summary server 103 and the enterprise insurance claim summary client devices 105, 107 may each be communicable with the other over a local area network (LAN), or if the enterprise is large enough, a wide area network (WAN).

Of course, the enterprise insurance claim summary server 103 operates to facilitate a user accessing important information related to a particular claim in a quick and efficient manner. As such, it should be expected that the enterprise insurance claim summary server 103 will communicate with remote end user insurance claim summary client devices 111, 113. The remote end user insurance claim summary client devices 111, 113 will typically be an insurance adjuster who, remote from the enterprise insurance claim summary server 103, wants to quickly and efficiently retrieve important information related to a particular claim.

Succinctly put, the enterprise insurance claim summary server 103 is therefore designed to be able to communicate remotely with client devices that belong to a different enterprise (illustrated in FIG. 1 as remote end user insurance claim summary client devices 111, 113) from the enterprise that is responsible for operation of the enterprise insurance claim summary server 103. Additionally, the enterprise insurance claim summary server 103 is designed to communicate with programmers, administrators, and other enterprise employees who operate the server 103 at other machines on the enterprise networks (illustrated in FIG. 1 as enterprise insurance claim summary client devices 105, 107). Of course, it should be expressly noted that the enterprise insurance claim summary server 103 may be operated either directly at the device itself or from enterprise insurance claim summary client devices 105, 107 over the enterprise network 101. Significantly more detail related to the insurance claim summary system 100 and its components is now provided.

Each of the enterprise insurance claim summary server 103, the enterprise insurance claim summary client devices 105, 107, and the remote end user insurance claim summary client devices 111, 113 may be viewed as a computer system. As described above, in one embodiment only the computer systems 103, 105, 107 may communicate over an enterprise network, however in other embodiments the computer systems 103, 105, 107, 111, 113 may each communicate with the other over any network such as the Internet, an intranet, or any other network. Each computer system 103, 105, 107, 111, 113 may be programmed to operate in automated fashion, and may also have an analog or a graphic user interface such as Outlook and Windows such that users can control computer systems 103, 105, 107, 111, 113. Each computer system 103, 105, 107, 111, 113 may include at least a central processing unit (CPU) with data storage such as disk drives, the number and type of which are variable. In each computer system 103, 105, 107, 111, 113, there might be one or more of the following: a floppy disk drive, a hard disk drive, a solid state drive, a CD ROM or digital video disk, or other form of digital recording device.

Each computer system 103, 105, 107, 111, 113 may include one or more displays upon which information may be displayed. Input peripherals, such as a keyboard and/or a pointing device, such as a mouse, may be provided in each computer system 103, 105, 107, 111, 113 as input devices to interface with each respective CPU. To increase input efficiency, the keyboard may be supplemented or replaced with a scanner, card reader, or other data input device. The pointing device may be a mouse, touch pad control device, track ball device, or any other type of pointing device.

Each computer system 103, 105, 107, 111, 113 may interconnects peripherals previously mentioned herein through a bus supported by a bus structure and protocol. The bus may serve as the main source of communication between components of each computer system 103, 105, 107, 111, 113. The bus in each computer system 103, 105, 107, 111, 113 may be connected via an interface.

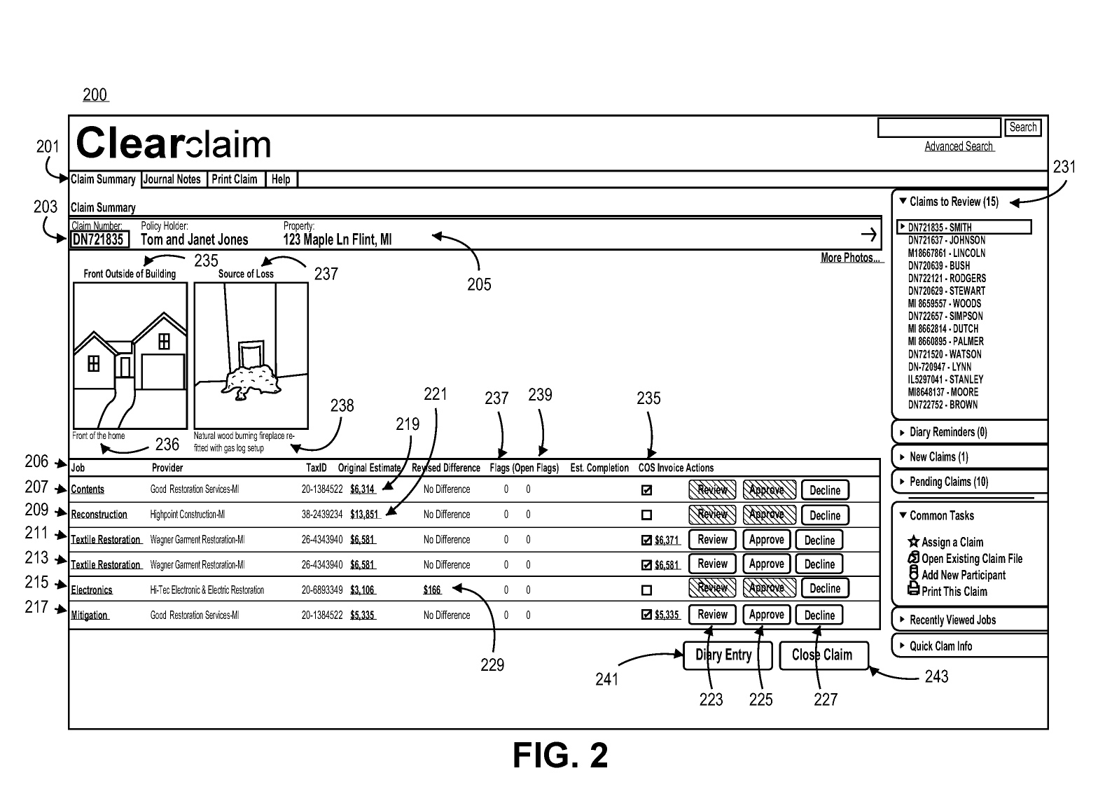

The CPU of each computer system 103, 105, 107, 111, 113 may perform the calculations and logic operations required to execute the functionality of each computer system as described in this disclosure and as illustrated in FIGS. 2-6. The functionality of each computer system 103, 105, 107, 111, 113 may be processed in an automated fashion such that relevant data is processed without user administrator assistance or intervention. Alternatively or additionally, the functionality of each computer system 103, 105, 107, 111, 113 may be processed in a semi-automatic fashion with intervention from a user administrator at one or more of the computer systems 103, 105, 107, 111, 113. Implementing, processing, and executing the functionality of each computer system 103, 105, 107, 111, 113 as described in this disclosure with respect to FIGS. 2-6 is within the purview and scope of one of ordinary skill in the art, and is not discussed in detail herein.

Each computer system 103, 105, 107, 111, 113 may be implemented as a distributed computer system or a single computer. Similarly, each computer system 103, 105, 107, 111, 113 may be a general purpose computer, or a specially programmed special purpose computer. Moreover, processing in each computer system 103, 105, 107, 111, 113 may be controlled by a software program on one or more computer systems or processors, or could even be partially or wholly implemented in hardware. The computer systems 103, 105, 107, 111, 113 used in connection with the functionality described with reference to FIGS. 2-6 may rely on the integration of various components including, as appropriate and/or if desired, hardware and software servers, database engines, and/or other content providers.

Although the computer systems 103, 105, 107, 111, 113 in FIG. 1 are illustrated as being a single computer, each computer system according to one or more embodiments of the invention is optionally suitably equipped with a multitude or combination of processors or storage devices. For example, each computer illustrated in computer systems 103, 105, 107, 111, 113 may be replaced by, or combined with, any suitable processing system operative in accordance with the principles of embodiments of the present disclosure, including sophisticated calculators, hand-held smart phones, smartpads, laptop/notebook, mini, mainframe and super computers, as well as processing system network combinations of the same. Further, portions of each computer system 103, 105, 107, 111, 113 may be provided in any appropriate electronic format, including, for example, provided over a communication line as electronic signals, provided on floppy disk, provided on CD-ROM, provided on optical disk memory, etc.

Any presently available or future developed computer software language and/or hardware components can be employed in the computer systems 103, 105, 107, 111, 113. For example, at least some of the functionality mentioned above could be implemented using Visual Basic, C, C++ or any assembly language appropriate in view of the processor being used. It could also be written in an interpretive environment such as Java and transported to multiple destinations to various users.

It is likely that one or more the computer system 103, 105, 107, 111, 113 may be implemented on a web based computer, e.g., via an interface to collect and/or analyze data from many sources. User interfaces may be developed in connection with an HTML display format, XML, or any other mark-up language known in the art. It is possible to utilize alternative technology for displaying information, obtaining user instructions and for providing user interfaces.

As indicated above, each computer system 103, 105, 107, 111, 113 may be connected over the Internet, an Intranet, or over a further network. Links to any network may be a dedicated link, a modem over a POTS line, and/or any other method of communicating between computers and/or users.

Each computer system 103, 105, 107, 111, 113 may store collected information in a database. An appropriate database may be on a standard server, for example, a small Sun™ Sparc™ or other remote location. The information may, for example, optionally be stored on a platform that may, for example, be UNIX-based. The various databases may be in, for example, a UNIX format, but other standard data formats may be used. The database optionally is distributed and/or networked. Succinctly put, the computer systems 103, 105, 107, 111, 113 of the insurance claim summary system 100 may implement the functionality of the various embodiments described herein with respect to FIGS. 2-6 using any imaginable computing environment.

Turning now to FIG. 2, which illustrates a screen capture 200 demonstrating insurance claim summary functionality in general, is discussed and described. As indicated above, a claims adjuster or other user attempting to access insurance claim information must navigate voluminous pages in order to acquire the necessary information. FIG. 2 illustrates an adjuster claim summary page 201 which puts significant amounts of information related to a particular claim 203 on a single page. Navigation by a claims adjuster to obtain the information related to the particular claim 203 is thereby minimized.

As seen in FIG. 2, the insurance claim summary page 201 is associated with an insurance claim that is associated with a claim number DN721835. As discussed above, each particular insurance claim may involve multiple jobs associated therewith, each of the jobs aiding in a remediation of damage caused to the subject of the insurance claims. Thus for example, the insurance claim summary 201 indicates that the jobs 206 associated with the particular claim 203 with claim number DN721835 are a Contents job 207, a Reconstruction job 209, a Textile Restoration job 211, a second Textile Restoration job 213, an Electronics job 215, and a Mitigation job 217.

It should be noted that the jobs 206 listed on the insurance claim summary page 201 are only some of the different jobs that might be performed with respect to building or home damage. For example, other jobs that may be performed with respect to building or home damage include a Hazmat job, a Tree job, and a Mold job. These examples are not exclusive, and one of ordinary skill in the art would have knowledge of the many different type of jobs that might be performed in remediating and mitigating damage to a building and/or home.

It should also be understood that the various jobs associated with a particular claim may be in various stages of completion. Various job associated with a particular insurance claim may yet to be started, which is to say that they are intended to be undertaken. Some jobs may be already undertaken, yet others may have already been completed. It should be noted that the Contents job 207, the Textile Restoration jobs 211, 213, and the Mitigation job 217 have been completed as indicated by the check mark in the Certificate of Satisfaction (COS) Invoice Action box for each of these jobs.

As it described further below, the information accompanying the jobs 206 that are associated with claim number DN721835 provides all the information an adjuster needs to adequately address a particular insurance claim. However, each of the jobs 206 that is listed on the adjuster claim summary page 201 is in the form of a hyperlink (as indicated by the underlining). The hyperlinks should be understood to be a selectable job title. When a job title is selected, the user is then taken to the detailed information that is presented by the QuickLook and Overlook pages described above. That is to say, a claims adjuster (or other user) always has the ability to navigate back to the detailed information presented over multiple pages. Alternatively, the claims adjuster (or other user) can simply use the insurance claim summary page 201 to view the relevant information that she needs to aid in processing the insurance claim.

The insurance claim summary page 201 also includes for each job 206 associated with claim number DN721835 a dollar amount that represents an original written estimate of a cost to complete the respective job. Thus the insurance claim summary page 201, for example, includes an original estimate 219 for the Contents job 207 to be $6,314 and an original estimate 221 for the Reconstruction job 209 to be $13,851. The dollar amounts 219, 221 are selectable hyperlinks that when selected present an image of each respective original estimate.

The insurance claim summary page 201 also includes for each job 206, several estimate processing options with respect to the original written estimate of the cost to complete the respective jobs. Thus for example, for each original written estimate with respect to jobs 206, the processing options include reviewing the original written estimate 223, approving the original written estimate 225, and decline the original written estimate 227. These processing options are selectable such that when a user selects a processing option, the processing option is performed by server. That is to say, the original written estimate is either reviewed and indicated as such; approved and indicated as such; or declined and indicated as such.

It should be noted that there are particular processing steps in reviewing 223 an original written estimate. Specifically, when reviewing the original written estimate 223 is selected, the estimate is displayed to the user in a manner that provides for flagging items in the original estimate that need further consideration or action. That is to say, upon selecting an estimate for review, a claims adjuster user is presented with the original estimate that includes line itemization such that the adjuster can indicate items that either must be changed or have some further action taken.

When an original estimate is flagged by an adjuster for one or more items, the Flags setting 237 on the insurance claim summary page 201 will display a number that represents the total number of flags set by the adjuster. It should be clear that in the particular insurance claim summary 201 associated with claim number DN721835, none of the original estimates have been flagged as each Flag indicator 237 is set to zero. Once an original estimate has been reviewed and/or flagged, if a revised estimate is created (as discussed further below), the Open Flags indicator 239 will indicate the number of flags that remain open in the revised estimate.

It should be noted that a selected estimate processing option can always be changed. For example, although an adjuster (or other user) may initially approve an estimate (indicated by the word “Approved”), the user may later change the approval to a further review or decline. Additionally, an estimate processing function that is implemented subsequent to reviewing 223 the estimate, is a revising estimate function. If an adjuster makes substantive changes to an original estimate that include a change to the quantitative amount of the repair or remediation, the revising estimate function includes creating a revised estimate.

The revised estimate is indicated in the insurance claim summary page 201 through a second dollar amount 229. The second dollar amount 229 (indicated in FIG. 2 as $166) is simply the difference between the estimated cost provided in the original written estimate to complete the respective job and a revised cost provided in a revised estimate to complete the respective job. The second dollar amount 229 may be a positive number, indicating that the revised estimate is a higher value than the original estimate, or a negative number, indicating that the revised estimate is a lower value than the original estimate.

The second dollar amount 229 is presented as a selectable hyperlink. When the second dollar amount 229 is selected, the revised written estimate is displayed such that an adjuster user can further review the revised estimate or provide further flags. Once an original estimate is revised, the estimate processing options 223, 225, 227 are then available to be selected by a user as to the revised estimate, as described above.

The summary page 201 may further include a list 231 of other claims numbers that may be important to a particular claims adjuster or other user. Specifically, the adjuster may have several claims pending with the particular enterprise implementing the insurance claim summary system. Each of the listed claims numbers 231 is presented as a hyperlink. When any of the listed claims numbers is selected by the adjuster, the insurance claim summary page associated with the selected claim number is then displayed for further analysis and updating.

The insurance claim summary page 201 may further include photographs of the subject of the insurance claim. The photographs included in the summary page presented in FIG. 2 may be presented with a type indicator. In the case where the insurance claim relates to damage to an insured building or home, the type indicator may include, as illustrated in FIG. 2, the front outside of the building 235 and the source of loss 237. The photographs included in a summary page 201 may further include the following type indicators: a best example of damage, a best example of damage close-up, and a best example of completed work, as well as others type indicators that are known in the art as specifically relating to insurance claims.

Photographs presented in claim summary page 201 may also include a brief description of the photograph as written by the adjuster or other user. For example, in FIG. 2 the photograph identifying the front outside of the building 235 is described as being the front of the home 236. Further, the photograph identifying the source of loss 237 is described as a natural wood burning fireplace 238 refitted with gas log setup.

The photographs on an insurance claim summary page 201 are selectable by an adjuster or other user. When the adjuster selects a particular photograph, an enlarged image of the selected photograph is displayed. The enlarged photographs may allow an adjuster to see small items that might not be otherwise be viewable at a regular zoom level.

The insurance claim summary page 201 may also include a selectable diary/journal/note tab 241 that provides an adjuster or other user the ability to add written comments related to a particular insurance claim 203. Typically, the adjuster would add comments related to the actual loss itself with respect to the subject of the insurance claim. Additionally, the adjuster might want to add notes or entries related to the various jobs 206 undertaken with respect to the subject of the insurance claim.

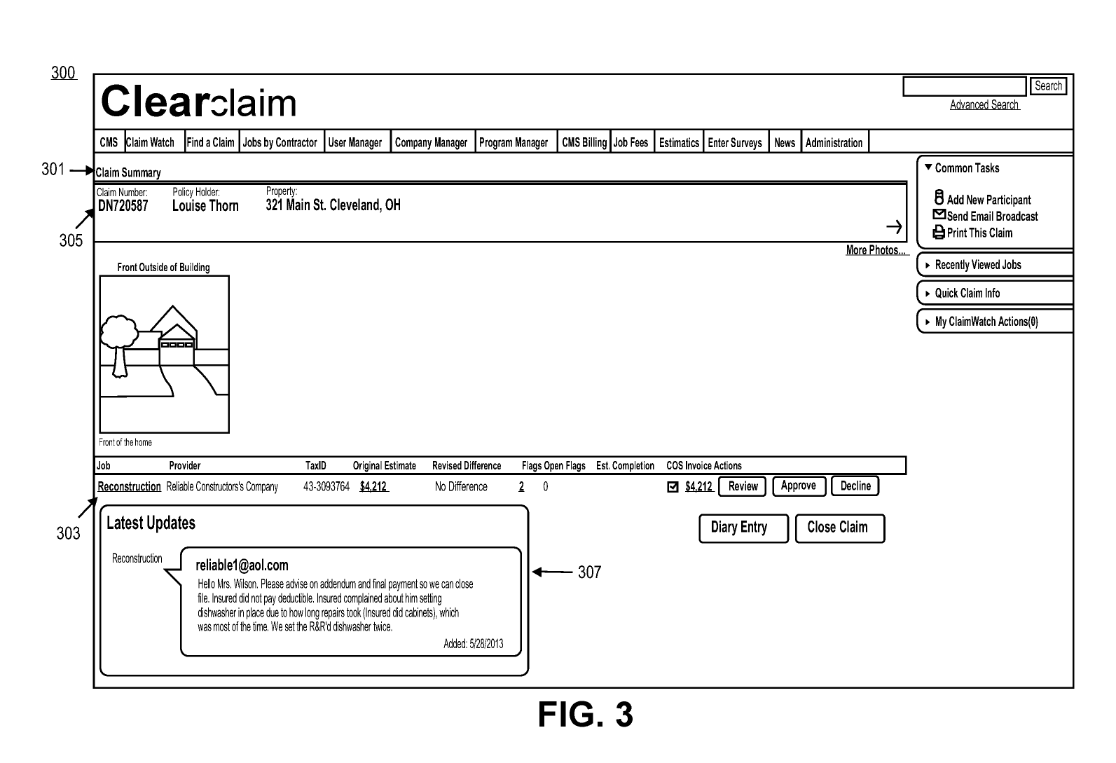

When a journal entry or note is provided by an adjuster or other user, it is displayed as part of the insurance claim summary page 201. FIG. 3, which is a screen capture 300 showing insurance claim summary functionality including a note/journal functionality, is now discussed and described. Specifically, the screen capture 300 shows an insurance claim summary page 301 that is similar to the insurance claim summary page 201 in FIG. 2, except that an adjuster has added a note 307 related to the reconstruction job 303 ongoing related to a particular claim 305 given by claim number DN720587. The note 307 relates to payment and performance of the reconstruction job 303 by the chosen contractor.

Turning back now to FIG. 2, the insurance claim summary page 201 may also include payment information related to payment on one or more of the jobs 206. Payment may be recorded on a particular job either through a tab (not shown) on the insurance claim summary page 201 or through a separate page. In either case, once recorded the payment information is displayed on the summary insurance claim summary page 201.

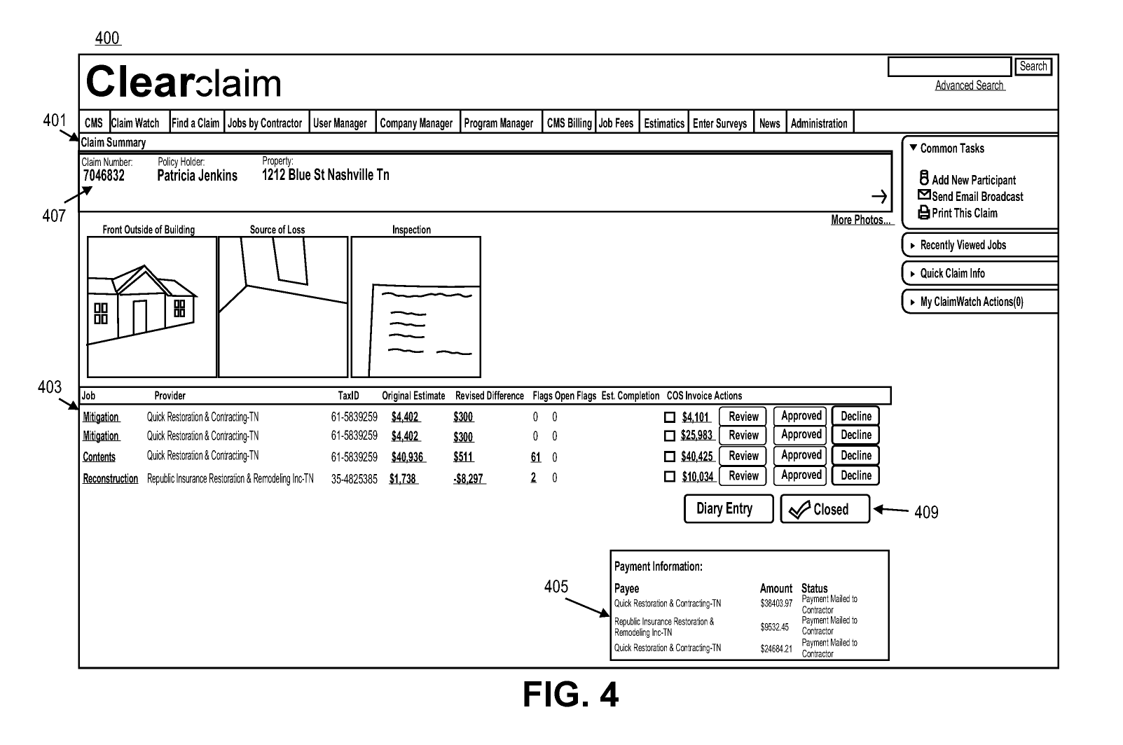

FIG. 4, which is a screen capture 400 demonstrating insurance claim summary functionality including payment information functionality, is now discussed and described. Specifically, the screen capture 400 shows an insurance claim summary page 401 that is similar to the insurance claim summary page 201 in FIG. 2, except that an adjuster has recorded payment information 405 related to the jobs 403 associated with the particular claim number 407 given by claim number 7046832. The payment information 405 in FIG. 4 simply demonstrates that the various contractors involved in the jobs 403 associated with claim number 7046832 have been mailed checks.

Turning back to FIG. 2 again, it should lastly noted that if all issues relating to a particular claim 203 have been finalized, the insurance claim summary page 201 provides a close claim tab 243 that can be used for indicating an ending to processing related to the particular claim 203. FIG. 4 further shows that when an adjuster or other user has selected a close claim tab, a check mark appears in the close claim tab 409 to indicate that the particular claim 407 has been closed as to additional processing.

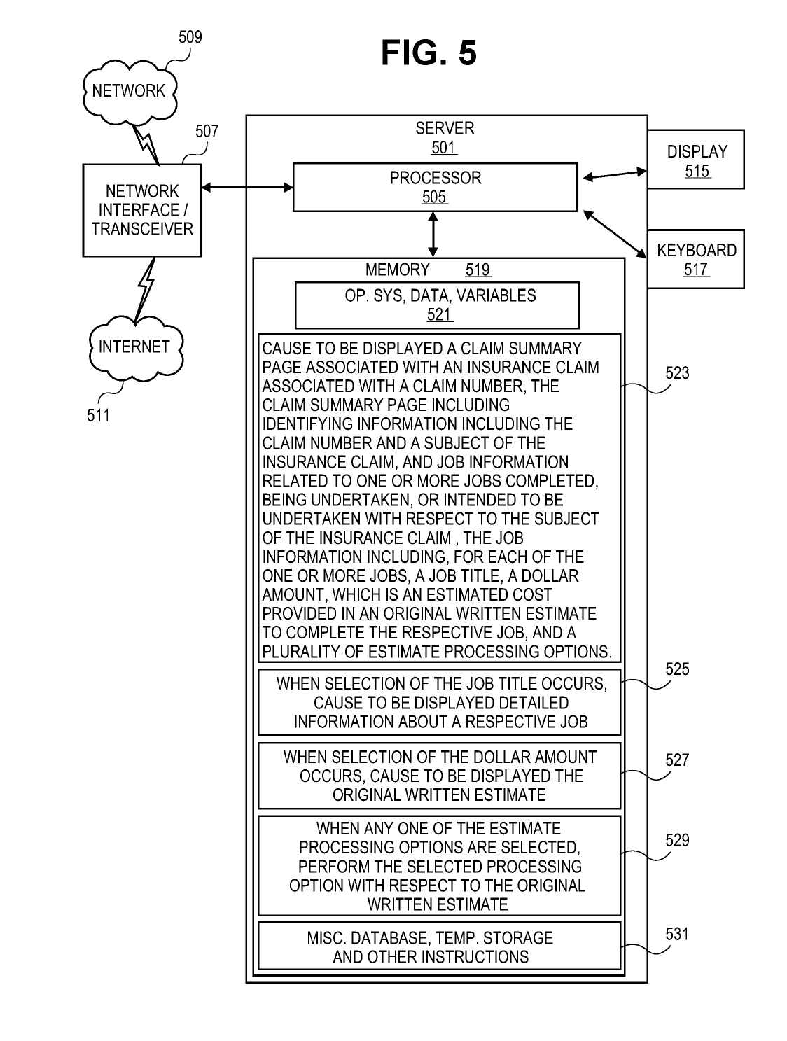

Succinctly put, the insurance claim summary page disclosed herein facilitates quick access to information by claims adjusters and other users. FIG. 5, which is a block diagram illustrating an insurance claim summary server 501 configured to implement insurance claim summary functionality, is discussed and described. The insurance claim summary server 501 may include a transceiver 507, a processor 505, a memory 519, a display mechanism 515, and a keypad and/or touch screen 517. The transceiver 507 may be equipped with a network interface that allows the insurance claim summary server 501 to communicate with other devices in an enterprise or other network 509 or over the Internet 511. Alternatively, the network interface may be provided in separate component coupled with the transceiver 507.

The processor 505 may comprise one or more microprocessors and/or one or more digital signal processors. The memory 519 may be coupled to the processor 505 and may comprise a read-only memory (ROM), a random-access memory (RAM), a programmable ROM (PROM), and/or an electrically erasable read-only memory (EEPROM). The memory 519 may include multiple memory locations for storing, among other things, an operating system, data and variables 521 for computer programs executed by the processor 505.

The computer programs cause the processor 505 to operate in connection with various functions as now described. A display an insurance claim summary with identifying information and job information function 523 causes the processor 505 to cause to be displayed an insurance claim summary page associated with an insurance claim associated with a claim number, the insurance claim summary page including identifying information including the claim number and a subject of the insurance claim, and job information related to one or more jobs completed, being undertaken, or intended to be undertaken with respect to the subject of the insurance claim, the job information including for each of the one or more jobs, a job title, a dollar amount, which is an estimated cost provided in an original written estimate to complete the respective job, and plurality of estimate processing options.

A display detailed information function 525 causes the processor 505, when selection of the job title occurs, to cause to be displayed detailed information about a respective job. A display original estimate function 527 causes the processor 505, when selection of the dollar amount occurs, to cause to be displayed the original written estimate. A perform estimate processing options function 529 causes the processor, when any of the estimate processing options are selected, to perform the selected processing option with respect to the original written estimate.

The above describe functions stored as computer programs may be stored, for example, in ROM or PROM and may direct the processor 505 in controlling the operation of the insurance claim summary server 501. The memory 519 can additionally store a miscellaneous database and temporary storage 531 for storing other data and instructions not specifically mentioned herein.

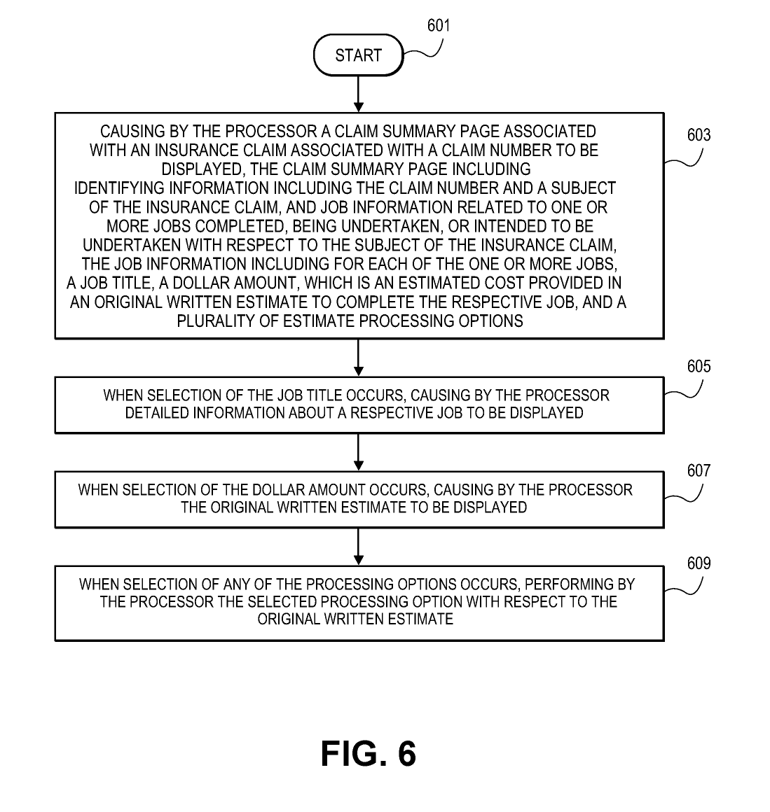

Referring now to FIG. 6, a flow chart illustrating an insurance claim summary method is discussed and described. The insurance claim summary method is advantageously implemented in an insurance claim summary server that comprises a transceiver, an electronic data storage, and a processor cooperatively operable with the transceiver and the electronic data storage. When an insurance claim summary page is requested, the insurance claim summary method begins 601.

The insurance claims summary method comprises causing 603 by the processor an insurance claim summary page associated with an insurance claim associated with a claim number to be displayed, the insurance claim summary page including identifying information including the claim number and a subject of the insurance claim, and job information related to one or more jobs completed, being undertaken, or intended to be undertaken with respect to the subject of the insurance claim, the job information including for each of the one or more jobs, a job title, a dollar amount, which is an estimated cost provided in an original written estimate to complete the respective job, and a plurality of estimate processing options.

The insurance claims summary method further comprises, when selection of the job title occurs, causing 605 by the processor detailed information about a respective job to be displayed. The method also comprises, when selection of the dollar amount occurs, causing 607 by the processor the original written estimate to be displayed. The method lastly comprises when selection of any of the processing options occurs, performing 509 by the processor the selected processing option with respect to the original written estimate.

As discussed above, facilitating user access to important information is not the only improvement that is needed in conventional insurance claims managements systems. Specifically there often are claims where for one reason or another, issues arise that create problems in efficiently managing satisfaction of the insurance claims. For example, many times the insured will have continuing complaints about the workmanship of a contractor. Other times issues arise as to the competences or professionalism of a particular adjuster. On occasion, an insured may have significant problems in obtaining payments. These examples are not exhaustive, but rather simply demonstrate a need for a mechanism by which an intermediary party to an insurance transaction can pay special attention to or watch the ongoing relationship between parties to an insurance transaction. That is to say, conventional insurance claims management systems do not provide a mechanism for tracking problem claims that need special attention.

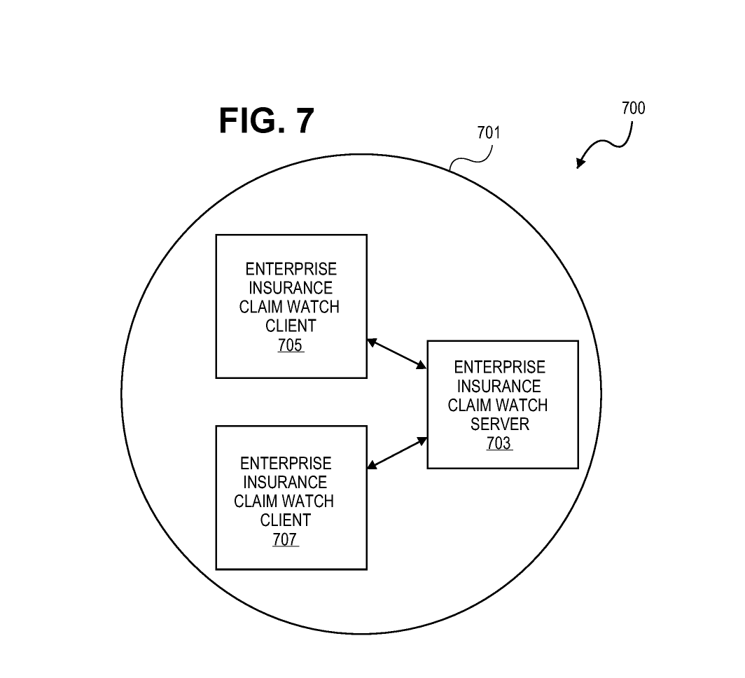

In this regard, FIG. 7, which is a block diagram illustrating an insurance claim watch system 700, including an insurance claim watch server 703 is discussed and described. The insurance claim watch system 700 includes an enterprise network 701. The enterprise network 701 includes an enterprise insurance claim watch server 703 and one or more enterprise insurance claim watch client devices 705, 707. As opposed to the insurance claim summary system described in detail above, the insurance claim watch system 700 is implemented over a single enterprise network 701 because the functionality of the system 700 relates to providing a mechanism identifying, segregating, and providing special attention to troublesome and/or problematic insurance claims. Once identified, these insurance claims requiring special attention can be organized so as to be easily identified.

The enterprise insurance claim watch server 703 may thus be operated by an enterprise which manages one or more insurance claims. While some of the functionality of the enterprise insurance claim watch server 703 may be performed autonomously, network administrators and other employees of the enterprise program operate the enterprise insurance claim watch server 703. Thus the enterprise insurance claim watch server 703 and the enterprise insurance claim watch client devices 705, 707 may each be communicable with the other over a local area network (LAN), or if the enterprise is large enough, a wide area network (WAN).

Succinctly put, the enterprise insurance claim watch server 703 is designed to communicate with programmers, administrators, and other enterprise employees who operate the server 703 via other machines on the enterprise networks (illustrated in FIG. 7 as enterprise insurance claim watch client devices 705, 707). Of course, it should be expressly noted that the enterprise insurance claim watch server 703 may be operated either directly at the device itself or from enterprise insurance claim watch client devices 705, 707 over the enterprise network 701. Significantly more detail related to the insurance claim watch system 700 and its components is now provided.

Each of the enterprise insurance claim watch server 703 and the enterprise insurance claim watch client devices 705, 707 may be viewed as a computer system. As described above, in one embodiment the computer systems 703, 705, 707 may communicate over an enterprise network, however in other embodiments the computer systems 703, 705, 707 may each communicate with the other over any network such as the Internet, an intranet, or any other network. Each computer system 703, 705, 707 may be programmed to operate in automated fashion, and may also have an analog or a graphic user interface such as Outlook and Windows such that users can control computer systems 703, 705, 707. Each computer system 703, 705, 707 may include at least a central processing unit (CPU) with data storage such as disk drives, the number and type of which are variable. In each computer system 703, 705, 707, there might be one or more of the following: a floppy disk drive, a hard disk drive, a solid state drive, a CD ROM or digital video disk, or other form of digital recording device.

Each computer system 703, 705, 707 may include one or more displays upon which information may be displayed. Input peripherals, such as a keyboard and/or a pointing device, such as a mouse, may be provided in each computer system 703, 705, 707 as input devices to interface with each respective CPU. To increase input efficiency, the keyboard may be supplemented or replaced with a scanner, card reader, or other data input device. The pointing device may be a mouse, touch pad control device, track ball device, or any other type of pointing device.

Each computer system 703, 705, 707 may interconnects peripherals previously mentioned herein through a bus supported by a bus structure and protocol. The bus may serve as the main source of communication between components of each computer system 703, 705, 707. The bus in each computer system 703, 705, 707 may be connected via an interface.

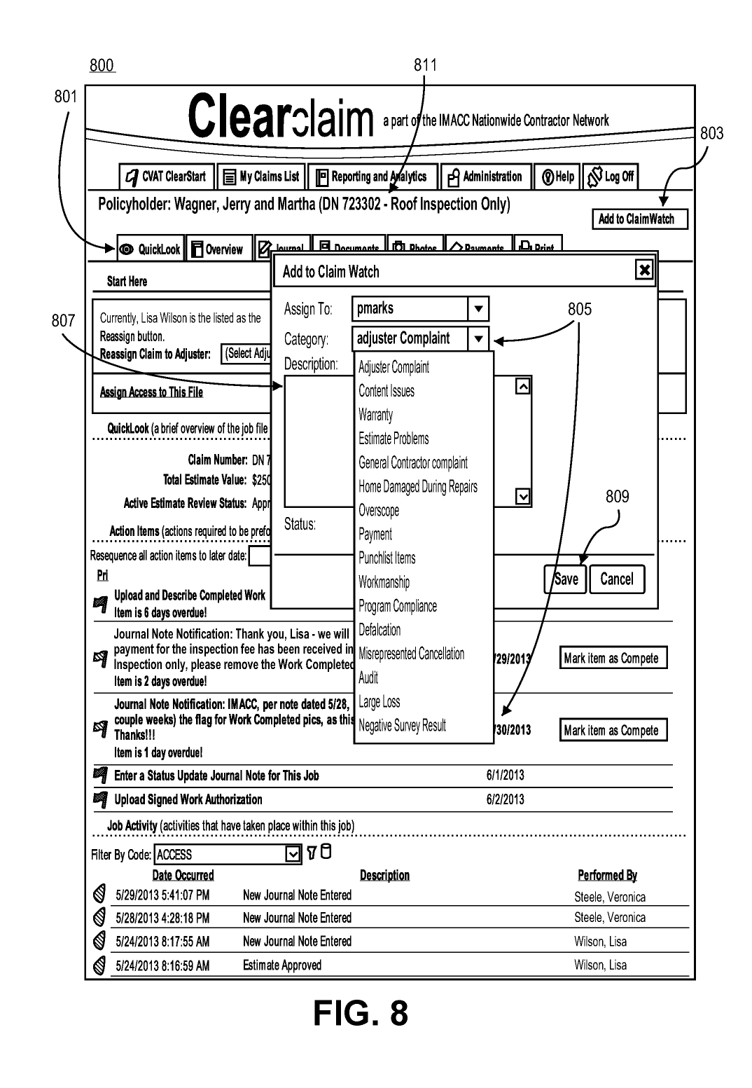

The CPU of each computer system 703, 705, 707 may perform the calculations and logic operations required to execute the functionality of each computer system as described in this disclosure and as illustrated in FIGS. 8-12. The functionality of each computer system 703, 705, 707 may be processed in an automated fashion such that relevant data is processed without user administrator assistance or intervention. Alternatively or additionally, the functionality of each computer system 703, 705, 707 may be processed in a semi-automatic fashion with intervention from a user administrator at one or more of the computer systems 703, 705, 707. Implementing, processing, and executing the functionality of each computer system 703, 705, 707 as described in this disclosure with respect to FIGS. 8-12 is within the purview and scope of one of ordinary skill in the art, and is not discussed in detail herein.

Each computer system 703, 705, 707 may be implemented as a distributed computer system or a single computer. Similarly, each computer system 703, 705, 707 may be a general purpose computer, or a specially programmed special purpose computer. Moreover, processing in each computer system 703, 705, 707 may be controlled by a software program on one or more computer systems or processors, or could even be partially or wholly implemented in hardware. The computer systems 703, 705, 707 used in connection with the functionality described with reference to FIGS. 8-12 may rely on the integration of various components including, as appropriate and/or if desired, hardware and software servers, database engines, and/or other content providers.

Although the computer systems 703, 705, 707 in FIG. 7 are illustrated as being a single computer, each computer system according to one or more embodiments of the invention is optionally suitably equipped with a multitude or combination of processors or storage devices. For example, each computer illustrated in computer systems 703, 705, 707 may be replaced by, or combined with, any suitable processing system operative in accordance with the principles of embodiments of the present disclosure, including sophisticated calculators, hand-held smart phones, smartpads, laptop/notebook, mini, mainframe and super computers, as well as processing system network combinations of the same. Further, portions of each computer system 703, 705, 707 may be provided in any appropriate electronic format, including, for example, provided over a communication line as electronic signals, provided on floppy disk, provided on CD-ROM, provided on optical disk memory, etc.

Any presently available or future developed computer software language and/or hardware components can be employed in the computer systems 703, 705, 707. For example, at least some of the functionality mentioned above could be implemented using Visual Basic, C, C++ or any assembly language appropriate in view of the processor being used. It could also be written in an interpretive environment such as Java and transported to multiple destinations to various users.

It is likely that one or more the computer system 703, 705, 707 may be implemented on a web based computer, e.g., via an interface to collect and/or analyze data from many sources. User interfaces may be developed in connection with an HTML display format, XML, or any other mark-up language known in the art. It is possible to utilize alternative technology for displaying information, obtaining user instructions and for providing user interfaces.

As indicated above, each computer system 703, 705, 707 may be connected over the Internet, an Intranet, or over a further network. Links to any network may be a dedicated link, a modem over a POTS line, and/or any other method of communicating between computers and/or users.

Each computer system 703, 705, 707 may store collected information in a database. An appropriate database may be on a standard server, for example, a small Sun™ Sparc™ or other remote location. The information may, for example, optionally be stored on a platform that may, for example, be UNIX-based. The various databases may be in, for example, a UNIX format, but other standard data formats may be used. The database optionally is distributed and/or networked. Succinctly put, the computer systems 703, 705, 707 of the insurance claim watch system 700 may implement the functionality of the various embodiments described herein with respect to FIGS. 8-12 using any imaginable computing environment.

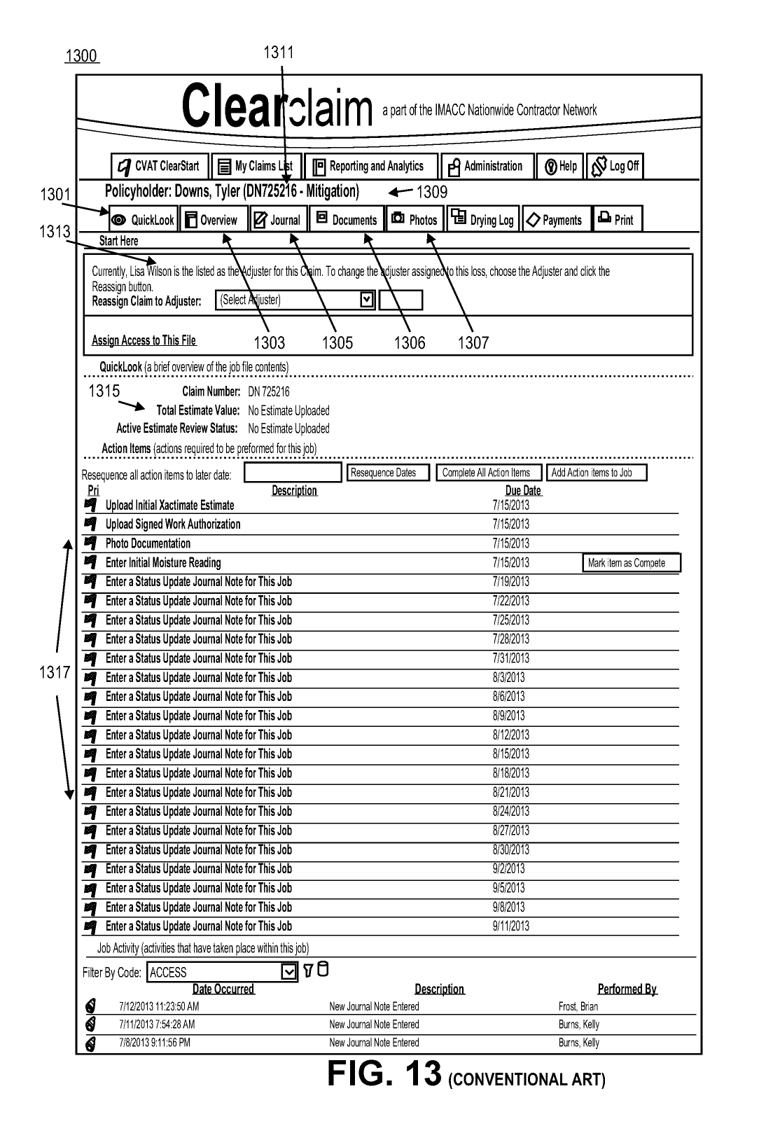

Turning now to FIG. 8, a screen capture 800 showing insurance claim watch functionality, including notification that a particular insurance claim requires special attention, is discussed and described. Initially, it should be noted that the screen capture 800 shows a QuickLook page 801 that is similar to the conventional QuickLook page 1301 of FIG. 13 in many respects. However, the QuickLook page 801 provides an “Add to Claim Watch” button 803 that allows an enterprise user or other user to indicate that a particular claim 811 may need special attention. In the embodiment illustrated in FIG. 8, the special attention is referred to as “Claim Watch.” As used herein, “Claim Watch” and special attention should be understood to be interchangeable. However, it should be clear that “Claim Watch” is simply one commercial representation of the idea of identifying and demarcating a particular insurance claim as requiring special attention, watching, and/or monitoring.

An insurance claim watch server receives an indication from a user that a particular claim 811 may require special attention, and then prompts the user for various information. Specifically, a prompt is displayed which provides a list of predefined reasons 805 from which the user can select a single reason as the reason that the insurance claim needs special attention. As seen in FIG. 8, the plurality of predefined reasons may include adjuster complaint, content issues, warranty, estimate problems, general contractor complaint, home damaged during repairs, overscope, payment, punchlist items, workmanship, program compliance, defalcation, misrepresented cancellation, audit, large loss, and negative survey result.

Once the user selects a single reason from the list of predefined reasons 805, the user may be prompted via a text box 807 to further provide a written description of why the insurance claim requires the special attention. The user either provides a brief written comment in the text box 807 or simply acknowledges the single reason from the list of predefined reasons 805. The user then selects a save button 809 for the insurance claim watch server to further record and demarcate the insurance claim as requiring special attention.

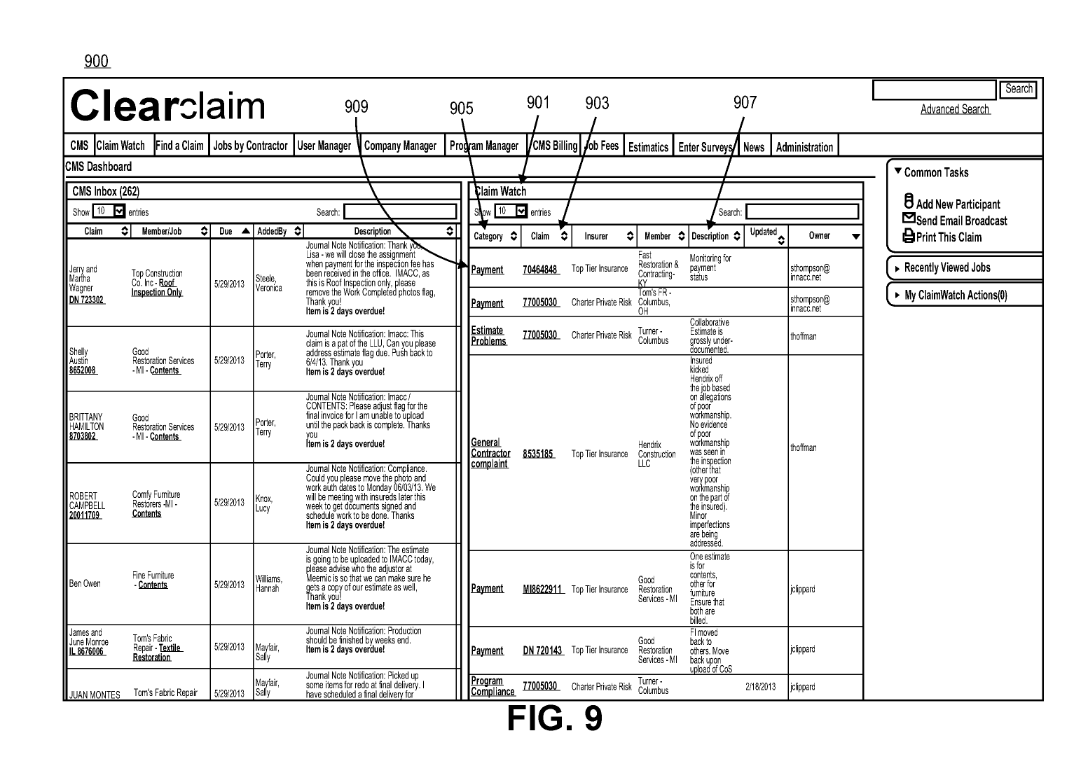

More specifically, when the user selects the save button 809, the particular insurance claim 811 is flagged so as to be included in a list of claims requiring special attention. Such a list is seen is FIG. 9, which is a screen capture showing insurance claim watch functionality including demarcation that a particular claim is being watched and the reasons therefore. Each claim that has been indicated by a user as requiring special attention appears in a Claim Watch list 901 which thereby demarcates the listed claims as being watched and/or as requiring special attention.

Each insurance claim provided in the Claim Watch list 901 is displayed with much of the information that has been received from the user. Specifically each insurance claim in the Claim Watch list 901 is displayed with the predefined reason (category) 905 for which the insurance claim is being watched and the claim number 903 of the insurance claim being watched. Additionally, if a user provided a brief written description (in response to the prompt 807 in FIG. 8) with respect to a watched claim, the watched claim is also listed in the Claim Watch list 901 with the brief description 907.

It should be quickly noted that the claim number associated with each claim appearing in the Claim Watch list 901 is provided as a hyperlink. Selection of any of the claim numbers 903 would conveniently navigate the user to an insurance claim summary page described in detail above. It should also be noted that the predefined reason 905 that is provided for each claim that is included in the Claim Watch list 901 is also provided as a hyperlink.

Selection of any of the hyperlinks that are provided as predefined reasons 905 results in a page of details opening related to the insurance claim with which the predefined reason is associated. Thus for example, when the predefined reason “Payment” 909 is selected, which is associated with watched claim number 7046848, a details page opens up. It should be noted, however, the provided details are actually details that have been provided by further prompts to an enterprise or other user. Thus, selection of one of the hyperlinks provided by the predefined reasons 905 actually results in a page of prompts being displayed with responses thereto included as the details.

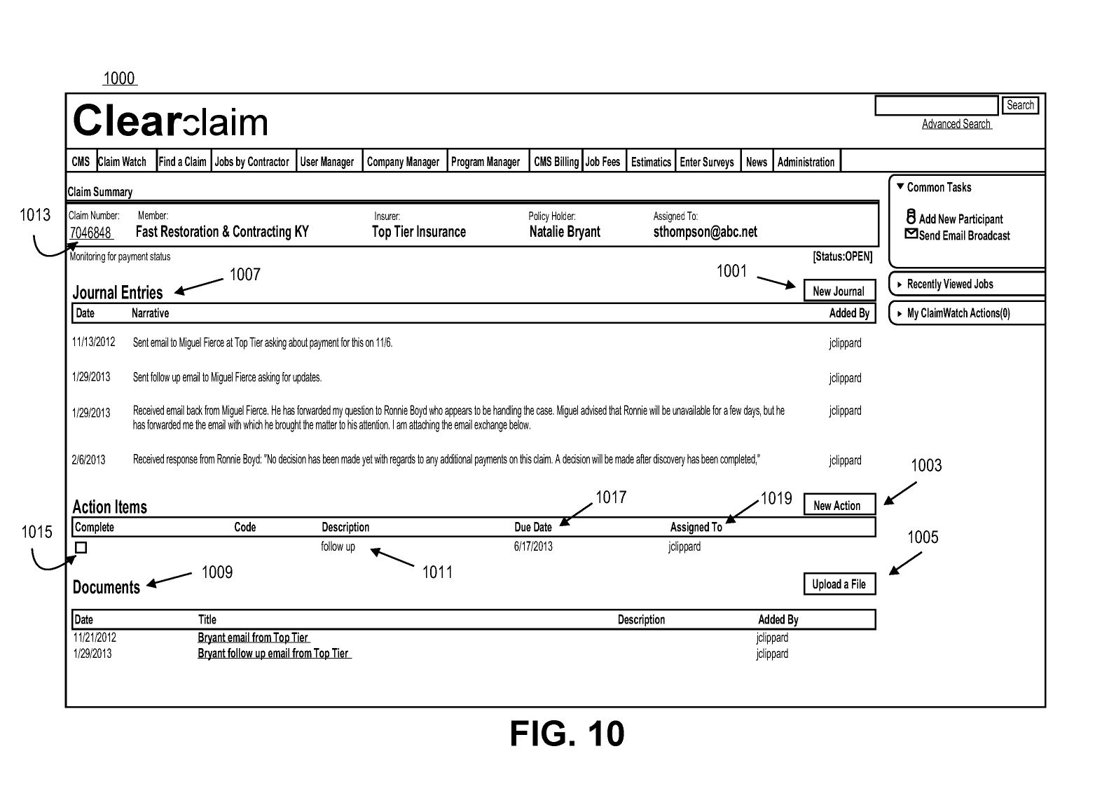

FIG. 10, which is a screen capture 1000 showing insurance claim watch functionality including displays of information related to a particular claim that is being watched, is now discussed and described. More specifically, the screen capture 1000 shows the various prompts 1001, 1003, 1005 that create the details related to the particular claim 1013 being watched. In FIG. 10, prompts and information related to particular claim 1013, given by claim number 7046848, are opened when the hyperlink represented by predefined reason “Payment” 909 in FIG. 9 is selected.

As FIG. 10 illustrates, subsequent to the insurance claim 1013 being demarcated as requiring special attention by being provided in the Claim Watch list 901, prompts are provided seeing additional journal entries 1001, seeking an indication of further action items 1003 that need to be taken with respect to the particular claim 1013, and also seeking additional documents 1005. Thus when the button 1001 for New Journal is selected by a user, a text box similar to the text box 807 in FIG. 8 opens that allows the user to enter additional notes or journal entries. When the user completes a new text entry, the text appears under the Journal Entries section 1007.

As indicated above, the user also has the opportunity add additional documents to the details of the particular claim 1013 being watched. Specifically, the user selects the “Upload a File” button 1005, and the user navigations a menu (as is known in the art) to obtain a file desired to be uploaded. Once the file is selected, the file is uploaded along with a brief title of the file to the insurance claim watch server. A hyperlink with the brief title of the file then appears under the Documents section 1009 of the details page. The user of course can select any hyperlink under the Documents section 1009. When the user selects a hyperlink in the Documents section 109, the underlying document in full is displayed.

As indicated above, the insurance claim watch system also prompts the user for additional action items 1003 that may need to be taken with respect the particular claim 1013 that is being watched or segregated or demarcated as requiring special attention. When the user selects the new action button 1003, a text box is opened that prompts the user for very brief written description 1011 of an additional action that needs to be taken with respect to the particular claim 1013. The user must also indicate a due date 1017 and a responsible person 1019 to whom the action item is assigned. When all of the information related to the new action item (including the action, the due date, and the responsible person) is received by the insurance claim watch server, the insurance claim watch server causes the action items to be displayed.

It should be noted that the insurance claim watcher server additionally causes the display of a completion indicator 1015. The completion indicator 1015 represents whether a particular action item has been completed or is incomplete. The completion indicator 1015 is a check box. It is anticipated that eventually, most action items will be completed by the responsible person 1019.

When the responsible person 1019 completes the action item, the responsible person 1019 selects the checkbox 1015. This acts as a notification that action item is complete. A check mark, or an “x,” or some other mark is then displayed inside the checkbox 1015. The mark inside the checkbox 1015 thus indicates that the action item is complete. It should be noted that there may be additional mechanisms on other web or application pages (as is known in the art) where a user can indicate an action item being complete, such that a mark can appear in checkbox 1015.

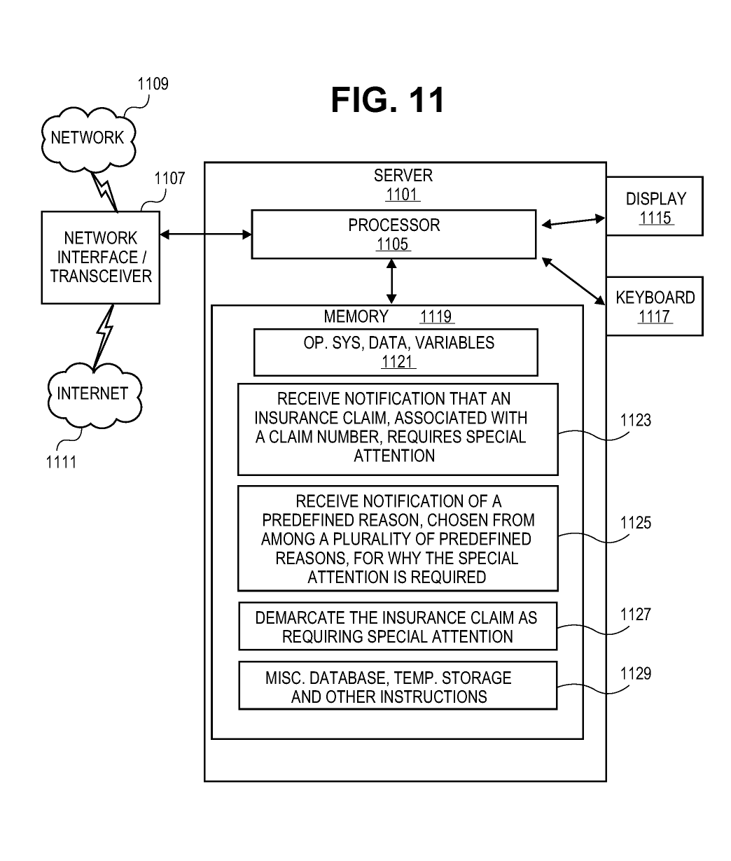

FIG. 11, which is a block diagram illustrating an insurance claim watch server 1101 configured to implement insurance claim watch functionality, is now discussed and described. The insurance claim watch server 1101 may include a transceiver 1107, a processor 1105, a memory 1119, a display mechanism 1115, and a keypad and/or touch screen 1117. The transceiver 1107 may be equipped with a network interface that allows the insurance claim watch server 1101 to communicate with other devices in an enterprise or other network 1109 or over the Internet 1111. Alternatively, the network interface may be provided in separate component coupled with the transceiver 1107.

The processor 1105 may comprise one or more microprocessors and/or one or more digital signal processors. The memory 1119 may be coupled to the processor 1105 and may comprise a read-only memory (ROM), a random-access memory (RAM), a programmable ROM (PROM), and/or an electrically erasable read-only memory (EEPROM). The memory 1119 may include multiple memory locations for storing, among other things, an operating system, data and variables 1121 for computer programs executed by the processor 1105.

The computer programs cause the processor 1105 to operate in connection with various functions as now described. A receiving claim watch notification function 1123 causes the processor to receive notification that an insurance claim, associated with a claim number, requires special attention. A receiving predefined reason function 1125 causes the processor to receive notification of a predefined reason, chosen from among a plurality of predefined reasons, for why the special attention is required. A special attention demarcating function 1127 causes the processor to demarcate the insurance claim as requiring the special attention.

The above describe functions stored as computer programs may be stored, for example, in ROM or PROM and may direct the processor 1105 in controlling the operation of the insurance claim watch server 1101. The memory 1119 can additionally store a miscellaneous database and temporary storage 1129 for storing other data and instructions not specifically mentioned herein.

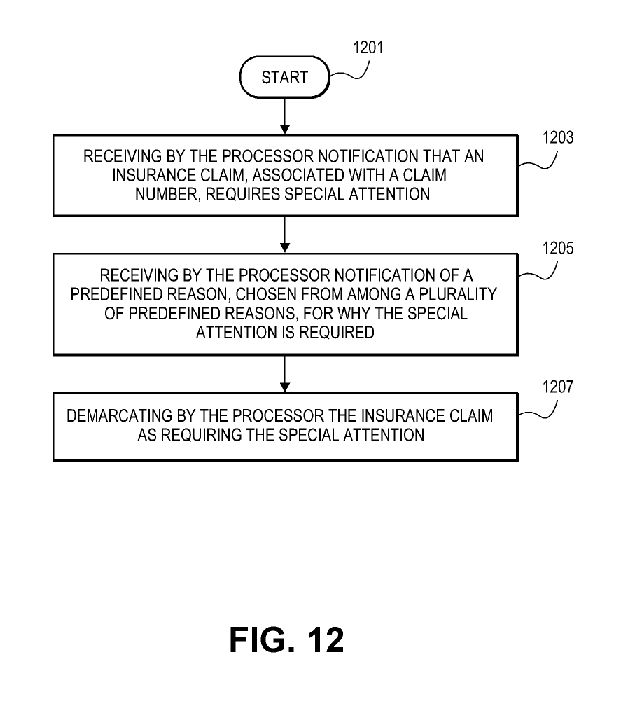

Referring now to FIG. 12, a flow chart illustrating an insurance claim watch method is discussed and described. The insurance claim watch method is advantageously implemented in an insurance claim watch server that comprises a transceiver, an electronic data storage, and a processor cooperatively operable with the transceiver and the electronic data storage. When an insurance claim is requested to be watched, the insurance claim watch method begins 1201.

The insurance claim watch method comprises receiving 1203 by the processor notification that an insurance claim, associated with a claim number, requires special attention. The insurance claim watch method further comprises receiving 1205 by the processor notification of a predefined reason, chosen from among a plurality of predefined reasons, for why the special attention is required. The insurance claim watch method lastly comprises demarcating 1207 by the processor the insurance claim as requiring the special attention.

This disclosure is intended to explain how to fashion and use various embodiments in accordance with the invention rather than to limit the true, intended, and fair scope and spirit thereof. The invention is defined solely by the appended claims, as they may be amended during the pendency of this application for patent, and all equivalents thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

1. An insurance claim summary server comprising:
a transceiver operable to transmit and receive communications over at least a portion of a network;
an electronic data storage; and
a processor cooperatively operable with the transceiver and the electronic data storage, the processor being configured to:
cause to be displayed an insurance claim summary page associated with an insurance claim associated with a claim number, the insurance claim summary page including:
identifying information including the claim number and a subject of the insurance claim, and
job information related to one or more jobs completed, being undertaken, or intended to be undertaken with respect to the subject of the insurance claim, the job information including, for each of the one or more jobs, a job title, a dollar amount, which is an estimated cost provided in an original written estimate to complete the respective job, and a plurality of estimate processing options;
when selection of the job title occurs, cause to be displayed detailed information about a respective job;
when selection of the dollar amount occurs, cause to be displayed the original written estimate; and
when any one of the plurality of estimate processing options is selected, perform the selected processing option with respect to the original written estimate.

2. The insurance claim summary server according to claim 1, wherein
the plurality of estimate processing options includes reviewing the original written estimate, approving the original written estimate, and denying the original written estimate.

3. The insurance claim summary server according to claim 2, wherein
the processor is further configured to, when reviewing the original written estimate is selected, cause to be displayed the original written estimate such that one or more items comprising the original written estimate can be noted for further action.

4. The insurance claim summary server according to claim 3, wherein
the job information further includes a second dollar amount, which is a difference between the estimated cost provided in the original written estimate to complete the respective job and a revised cost provided in a revised estimate to complete the respective job, and
the processor if further configured to, when the second dollar amount is selected, cause to be displayed the revised written estimate.

5. (canceled)

6. The insurance claim summary server according to claim 1, wherein
the insurance claim summary page further includes one or more photographs of the subject of insurance claim, and
the processor if further configured to, when any of the one or more photographs of the subject of the insurance claims is selected, cause to be displayed an enlarged image of the selected photograph.

7. The insurance claim summary server according to claim 6, wherein
the one or more photographs include photographs of one or more of a front outside of a building, a source of loss, a best example of damage, a best example of damage close-up, and a best example of completed work.

8. The insurance claim summary server according to claim 7, wherein the processor is further configured to
cause to be displayed a brief description of each of the one or more photographs.

9-10. (canceled)

11. An insurance claim summary method, implemented in an insurance claim summary server comprising a transceiver, an electronic data storage, and a processor cooperatively operable with the transceiver and the electronic data storage, the method comprising:
causing by the processor an insurance claim summary page associated with an insurance claim associated with a claim number to be displayed, the insurance claim summary page including:
identifying information including the claim number and a subject of the insurance claim, and
job information related to one or more jobs completed, being undertaken, or intended to be undertaken with respect to the subject of the insurance claim, the job information including, for each of the one or more jobs, a job title, a dollar amount, which is an estimated cost provided in an original written estimate to complete the respective job, and a plurality of estimate processing options;
when selection of the job title occurs, causing by the processor detailed information about a respective job to be displayed;
when selection of the dollar amount occurs, causing by the processor the original written estimate to be displayed; and
when selection of any of the plurality of processing options occurs, performing by the processor the selected processing option with respect to the original written estimate.

12. The insurance claim summary method according to claim 11, wherein
the plurality of estimate processing options includes reviewing the original written estimate, approving the original written estimate, and denying the original written estimate.

13. The insurance claim summary method according to claim 12, further comprising:
when reviewing the original written estimate is selected, causing by the processor the original written estimate to be displayed such that one or more items comprising the original written estimate can be noted for further action.

14. The insurance claim summary method according to claim 13, wherein
the job information further includes a second dollar amount, which is a difference between the estimated cost provided in the original written estimate to complete the respective job and a revised cost provided in a revised estimate to complete the respective job, and
the insurance claim summary method further comprises, when the second dollar amount is selected, causing by the processor the revised written estimate to be displayed.

15. (canceled)

16. The insurance claim summary method according to claim 11, wherein
the insurance claim summary page further includes one or more photographs of the subject of insurance claim, and
the insurance claim summary method further comprises, when any of the one or more photographs of the subject of insurance claim is selected, causing by the processor an enlarged image of the selected photograph to be displayed.

17. The insurance claim summary method according to claim 16, wherein
the one or more photographs include photographs of one or more of a front outside of a building, a source of loss, a best example of damage, a best example of damage close-up, and a best example of completed work.

18. The insurance claim summary method according to claim 17, further comprising:
causing by the processor a brief description of each of the one or more photographs to be displayed.

19-20. (canceled)

21. A non-transitory computer-readable storage medium with instructions stored thereon, that when executed by an insurance claim summary sever computer comprising a transceiver, an electronic data storage, and processor cooperatively operable with the transceiver and the electronic data storage, cause the insurance claim summary server computer to perform an insurance claim summary method comprising:
causing by the processor an insurance claim summary page associated with an insurance claim associated with a claim number to be displayed, the insurance claim summary page including:
identifying information including the claim number and a subject of the insurance claim, and
job information related to one or more jobs completed, being undertaken, or intended to be undertaken with respect to the subject of the insurance claim, the job information including, for each of the one or more jobs, a job title, a dollar amount, which is an estimated cost provided in an original written estimate to complete the respective job, and a plurality of estimate processing options;
when selection of the job title occurs, causing by the processor detailed information about a respective job to be displayed;
when selection of the dollar amount occurs, causing by the processor the original written estimate to be displayed; and
when selection of any of the plurality of processing options occurs, performing by the processor the selected estimate processing option with respect to the original written estimate.

22. The non-transitory computer-readable storage medium according to claim 21, wherein
the plurality of estimate processing options includes reviewing the original written estimate, approving the original written estimate, and denying the original written estimate.

23. The non-transitory computer-readable storage medium according to claim 22, wherein the method further comprises:
when reviewing the original written estimate is selected, causing by the processor the original written estimate to be displayed such that one or more items comprising the original written estimate can be noted for further action.

24. The non-transitory computer-readable storage medium according to claim 23, wherein
the job information further includes a second dollar amount, which is a difference between the estimated cost provided in the original written estimate to complete the respective job and a revised cost provided in a revised estimate to complete the respective job, and
the insurance claim summary method further comprises, when the second dollar amount is selected, causing by the processor the revised written estimate to be displayed.

25. (canceled)

26. The non-transitory computer-readable storage medium according to claim 21, wherein
the insurance claim summary page further includes one or more photographs of the subject of insurance claim,
the insurance claim summary method further comprises, when any of the one or more photographs of the subject of insurance claim is selected, causing by the processor an enlarged image of the selected photograph to be displayed.

27. The non-transitory computer-readable storage medium according to claim 26, wherein
the one or more photographs include photographs of one or more of a front outside of a building, a source of loss, a best example of damage, a best example of damage close-up, and a best example of completed work.

28-54. (canceled)
